(19) United States
(12) Patent Application Publication
(10) Pub. No.: US 2005/0006806 A1
(43) Pub. Date: Jan. 13, 2005

(54) Method of forming grooves in resin bobbin and device for forming grooves

(76) Inventors: Ryuichi Kanbe, Handa-city (JP); Mituyuki Hayashi, Nishio-city (JP)

Correspondence Address: HARNESS, DICKEY & PIERCE, P.L.C., P.O. BOX 828, BLOOMFIELD HILLS, MI, 48303, US

(21) Appl. No.: 10/887,176

(22) Filed: Jul. 8, 2004

(30) Foreign Application Priority Data
Jul. 10, 2003 (JP) 2003-272673

(51) Int. Cl. B29C 43/00

(52) U.S. Cl. 264/69; 264/319; 425/456; 425/385

(57) ABSTRACT

There is provided a method of forming grooves in a resin bobbin (90), and the resin bobbin (90) has a cylindrical portion around which a coil is wound and a plurality of grooves are formed on a surface of the cylindrical portion in the winding direction of the coil. While a forming die (2) for grooving is being pushed onto the surface of the cylindrical portion, the forming die (2) for grooving is vibrated, and the forming die (2) for grooving is separated from the surface of the cylindrical portion after the completion of grooving of the cylindrical portion.

### BACKGROUND OF THE INVENTION

1. Field of the Invention

The present invention relates to a method of manufacturing a resin bobbin having grooves around which a field coil of a rotary electric machine for vehicle use is wound. The present invention also relates to a device for forming grooves in the resin bobbin.

2. Description of the Related Art

Conventionally, resin bobbins, around which coils are wound, have been used for rotary electric machines such as AC generators and starters for vehicle use. Recently, there has been a demand of downsizing parts of the rotary electric machines. Further, there has been a demand of increasing output power of the rotary electric machines. In order to meet the demands, it has become necessary to increase the number of turns while the space factor is being enhanced by regularly winding the coil around the resin bobbin. As one of the methods, a method is provided in which a plurality of grooves are formed on a surface of the cylindrical portion of the resin bobbin in the winding direction. Usually, when the resin bobbin is formed, these grooves are simultaneously formed by using a forming die, on the surface of which irregularities are formed.

In this connection, in the case where irregularities are formed on the forming die described above and the grooves are formed in the resin bobbin simultaneously when the resin bobbin is formed with the die, shapes of the grooves are determined by the shapes of irregularities formed on the forming die. Therefore, it is necessary to make a new forming die each time the specification of the resin bobbin is changed. Therefore, when various types of resin bobbins are used, the cost is increased for manufacturing and maintaining various types of forming dies.

In the case where there are provided a plurality of resin bobbins, the appearances and shapes of which are substantially the same with each other and only the diameters of the coils of which are different from each other, it is difficult to visually distinguish the differences of these resin bobbins. Accordingly, there is a possibility that the assembling work is erroneously conducted. Especially when the manufacturing process of manufacturing the resin bobbin and the winding process of winding the coil are conducted at a distant place or when the resin bobbin is purchased from another manufacturer and winding is conducted around the resin bobbin, there is a higher possibility that the assembling work is erroneously conducted.

### SUMMARY OF THE INVENTION

The present invention has been accomplished to solve the above problems of the prior art. It is an object of the present invention to provide a method of forming grooves in a resin bobbin. It is another object of the present invention to provide a device for forming the grooves.

In order to solve the above problems, the present invention provides a method of forming grooves in a resin bobbin, the resin bobbin having a cylindrical portion around which a coil is wound, a plurality of grooves being formed on a surface of the cylindrical portion in the winding direction of the coil, the method of forming grooves in a resin bobbin comprising: a first step of pushing a forming die for grooving onto the surface of the cylindrical portion; a second step of vibrating at least one of the forming die for grooving and the resin bobbin; and a third step of separating the forming die for grooving from the surface of the cylindrical portion after the completion of grooving conducted on the cylindrical portion. Due to the foregoing, the grooves can be formed in the resin bobbin by the forming die for grooving which is different from the forming die used for manufacturing the resin bobbin. Therefore, when various types of resin bobbins are manufactured, it is possible to decrease the number of types of resin bobbins. Accordingly, in the case of changing the specification of a coil, it is possible to cope with the change in the specification by only changing the forming die for grooving. Consequently, it is possible to suppress an increase in the manufacturing cost of the resin bobbin. Further, as the grooves are formed after the resin bobbin has been manufactured, the grooves can be formed immediately before the coil is wound around the resin bobbin. Accordingly, the occurrence of erroneous assembling, in which a coil of a different diameter is erroneously wound around the resin bobbin, can be prevented.

It is preferable that the first and the second steps described above are simultaneously conducted. Due to the foregoing, grooves of desired shapes can be easily formed.

It is preferable that a plurality of protruding portions and recess portions are alternately and continuously formed on a pushing face of the forming die for grooving opposed to the cylindrical portion. Due to the foregoing, grooves having irregularities corresponding to the shapes of the recess portions and the protruding portions can be positively formed. When the shapes and intervals of the recess portions and the protruding portions are changed, the design of the grooves can be easily changed.

It is preferable that the forming die for grooving includes an opposing face opposing to a portion of the cylindrical portion in the circumferential direction. Due to the foregoing, the grooves can be formed when the forming die for grooving is pushed to the cylindrical portion in one direction. Therefore, the process can be simplified. When the forming die for grooving is downsized, the holding mechanism of holding the forming die for grooving and the vibrator for giving vibration can be downsized.

It is preferable that the first to the third step are repeated a plurality of times by changing a position of the cylindrical portion to which the forming die for grooving is pushed. Due to the foregoing, grooves can be formed on all of the circumference of the cylindrical portion by using a small forming die for grooving with respect to the cylindrical portion. Therefore, the grooving device can be downsized.

It is preferable that after the forming die for grooving has been pushed to the cylindrical portion in the first step, the forming die for grooving is vibrated in the second step, and after the forming die for grooving is moved in the pushing direction by a predetermined distance, vibration is stopped. Due to the foregoing, grooves, the depths of which are predetermined, can be formed in the resin bobbin in the radial direction. When the forming die for grooving is vibrated after the completion of pushing, the positioning accuracy can be enhanced at the time of pushing.

It is preferable that a cross section of the cylindrical portion is polygonal and the grooves are formed at corners of the polygonal section. Due to the foregoing, an area in which the grooves are formed can be reduced. Therefore, a position of the coil can be restricted by these grooves.

It is preferable that ultrasonic vibration is given in the second step. Due to the foregoing, the forming die for grooving can be relatively easily vibrated, and the groove forming device can be downsized.

It is preferable that the second step is conducted in a state in which the forming die for grooving is heated. Due to the foregoing, grooves can be more easily formed.

The present invention provides a device of forming grooves comprising: a bobbin holder for holding a resin bobbin; a forming die for grooving in which protruding portions and recess portions are alternately formed on a pushing face for pushing the resin bobbin; a pushing mechanism for pushing the forming die for grooving onto a surface of the cylindrical portion of the resin bobbin; and a vibrating mechanism of vibrating at least one of the forming die for grooving and the resin bobbin at the time of pushing by the pushing mechanism. Due to the foregoing, grooves can be formed in the resin bobbin by the forming die for grooving which is different from the forming die used for manufacturing the resin bobbin. Therefore, in the case of manufacturing various types of resin bobbins, the types of the resin bobbin forming dies can be reduced. Accordingly, in the case of a change in the specification of the coil, it is possible to cope with the change only by changing the forming die for grooving. Accordingly, an increase in the cost of manufacturing the resin bobbin can be suppressed. As the grooves are formed after the resin bobbin has been manufactured, it is possible to form the grooves immediately before the coil is wound around the resin bobbin. Accordingly, it is possible to prevent the occurrence of erroneous assembling in which a coil having a different diameter is erroneously wound around the resin bobbin.

The present invention may be more fully understood from the description of preferred embodiments of the invention set forth below, together with the accompanying drawings.

### BRIEF DESCRIPTION OF THE DRAWINGS

In the drawings:

FIG. 1 is an overall arrangement view of a groove forming device of an embodiment;

FIG. 2 is a view showing a method of pushing a forming die for grooving;

FIG. 3 is a view showing a method of pushing a forming die for grooving;

FIG. 4 is a perspective view showing a detailed shape of the pushing face of the forming die for grooving;

FIG. 5 is a perspective view showing a partial shape of the resin bobbin before the grooves are formed;

FIG. 6 is a perspective view showing a partial shape of the resin bobbin after the grooves are formed;

FIG. 7 is a partial cross sectional view of the resin bobbin; and

FIG. 8 is a flow chart showing a procedure of forming grooves.

### DESCRIPTION OF THE PREFERRED EMBODIMENTS

Referring to the drawings, a device for forming grooves of an embodiment of the present invention will be explained in detail below.

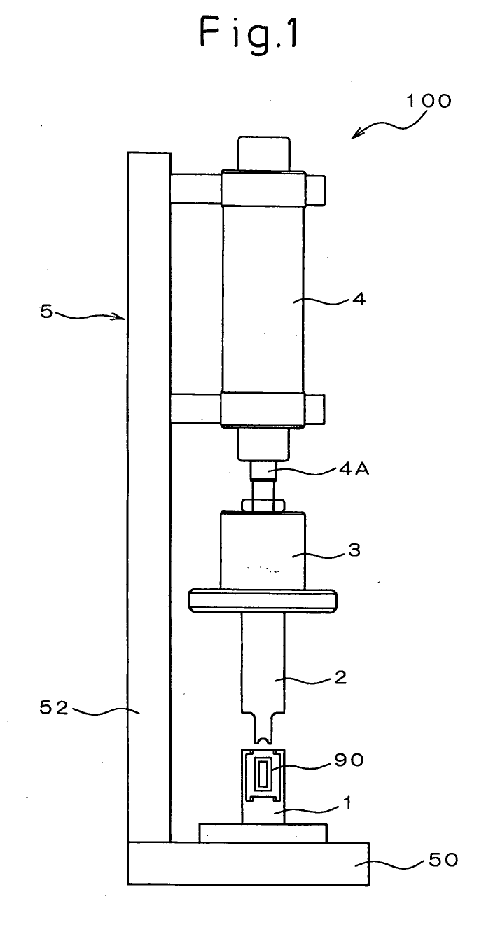

FIG. 1 is an overall arrangement view of a groove forming device of an embodiment. As shown in FIG. 1, the groove forming device 100 of this embodiment includes a bobbin holder 1, a forming die 2 for grooving, a vibrator 3, a cylinder 4 and a frame 5.

The bobbin holder 1 holds a resin bobbin 90, which is an object to be grooved, at a predetermined position. The entire bobbin holder 1 is pivotally attached. Therefore, when the bobbin holder 1 is rotated, a face of the resin bobbin 90, on which the grooves are to be formed, can be inverted in the vertical direction.

When the forming die 2 for grooving is pushed onto the objective face of the resin bobbin 90 on which the grooves are to be formed, a plurality of grooves are formed on this objective face of the resin bobbin 90. This forming die 2 for grooving is made of a metal or a non-metal. The vibrator 3 is a vibrating mechanism to generate ultrasonic vibration in the entire forming die 2 for grooving. The forming die 2 for grooving is attached to the vibrator 3 so that the objective face, on which the grooves having a plurality of protruding portions and recess portions are formed, can be directed downward.

The cylinder 4 is a pushing mechanism for pushing the resin bobbin 90. When the rod 4A conducts a stroke motion, the vibrator 3 attached to a lower end portion of the rod 4A and the forming die 2 for grooving connected to this vibrator 3 are moved upward and downward. When the vibrator 3 is moved downward, the protruding portions and the recess portions of the forming die for grooving, which is attached to the lower end of the vibrator 3, can be pushed to predetermined positions of the resin bobbin 90. When the vibrator 3 is moved upward, the forming die 2 for grooving can be separated from the resin bobbin 90 in which the groove formation has been completed.

The frame 5 includes: a base 50 on which the bobbin holder 1 is mounted and fixed; and a support 52 which is perpendicularly attached to a portion of the base 50. The cylinder 4 is attached to an upper portion of the support 52.

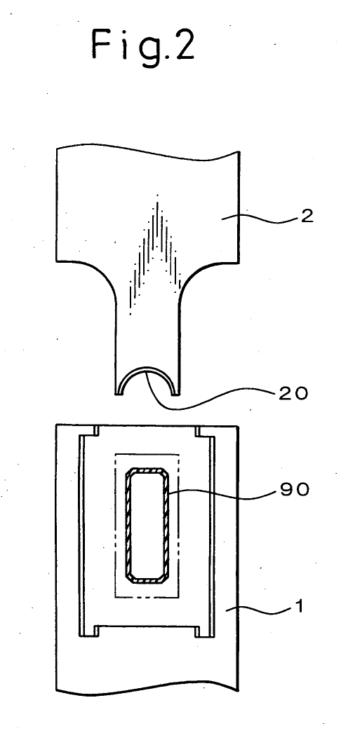

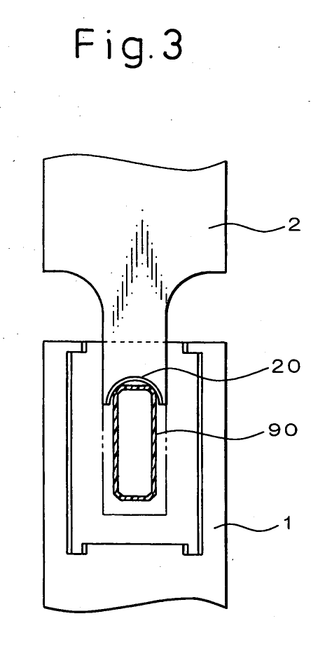

FIGS. 2 and 3 are views showing a method of pushing the forming die 2 for grooving.

Before the grooves are formed, as shown in FIG. 2, the forming die 2 for grooving is arranged in an upper portion of the resin bobbin 90 held by the bobbin holder 1. At the time of forming the grooves, as shown in FIG. 3, the forming die 2 for grooving is lowered until the pushing face 20 on the lower side of the forming die 2 for grooving is pushed onto a surface of the resin bobbin 90.

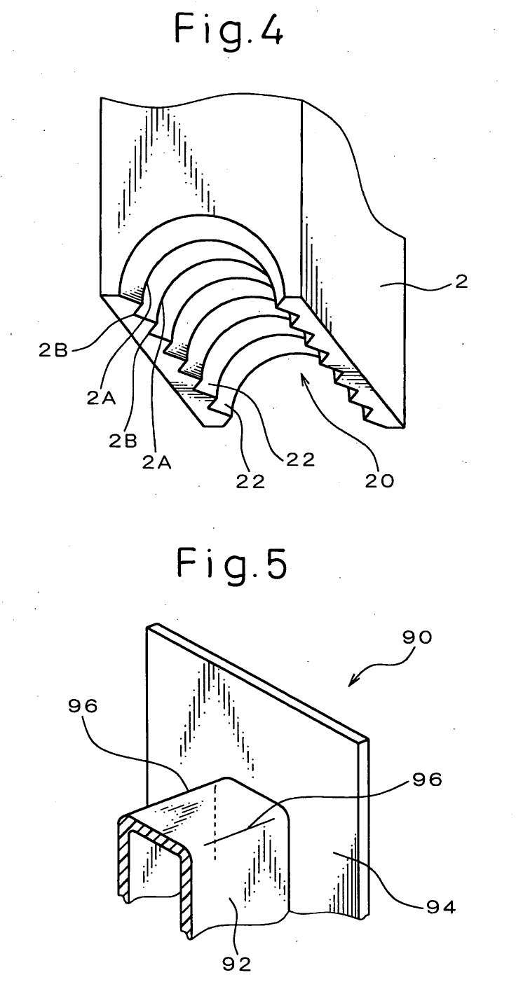

FIG. 4 is a perspective view showing a detailed shape of the pushing face 20 of the forming die 2 for grooving. As shown in FIG. 4, the forming die 2 for grooving includes a plurality of grooves 22 having a plurality of protruding portions 2A and recess portions 2B which are alternately arranged on the pushing face and on the lower side.

FIG. 5 is a perspective view showing a partial shape of the resin bobbin 90 before the grooves are formed. Before the grooves are formed, the resin bobbin 90 includes: a cylindrical portion 92, the cross section of which is polygonal; and side portions 94 provided at both end portions. In this connection, only one of the side portions 94 is shown in FIG. 4. For example, a cross section of the cylindrical portion 92 is square, and grooves are formed at four corners 96. A cross section of the pushing face 20 of the forming die 2 for grooving is cylindrical so that the pushing face 20 can cover two of the four corners 96.

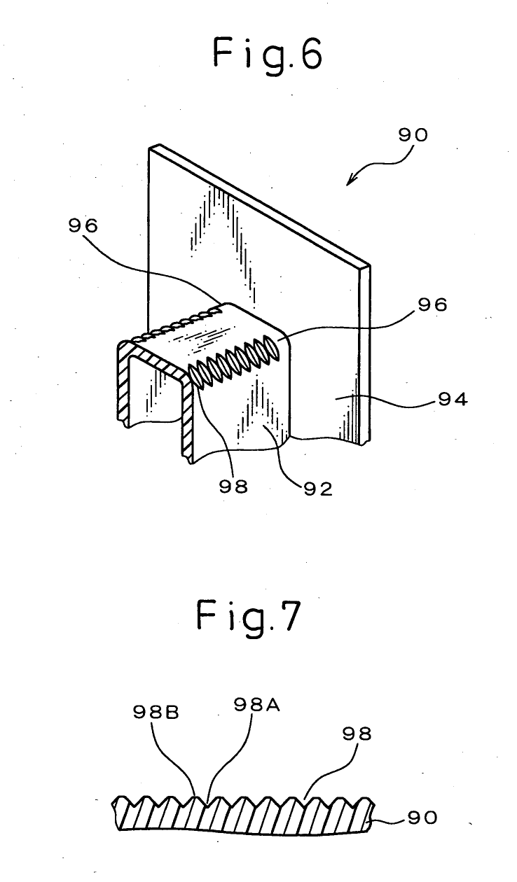

FIG. 6 is a perspective view showing a partial shape of the resin bobbin 90 after the grooves have been formed. FIG. 7 is a partial cross sectional view showing the resin bobbin 90. As shown in FIG. 6, when the cylindrical portion 92 of the resin bobbin 90 is pushed by the forming die 2 for grooving in one direction while the forming die 2 for grooving is being vibrated, a plurality of grooves 98 are formed in each corner 96. As shown in FIG. 7, these grooves 98 includes: recess portions 98A corresponding to the protruding portions 2A of the forming die 2 for grooving; and protruding portions 98B corresponding to the recess portions 2B of the forming die 2 for grooving.

The groove forming device 100 of this embodiment is composed as described above. Next, an explanation will be made of a procedure of forming grooves in the resin bobbin 90.

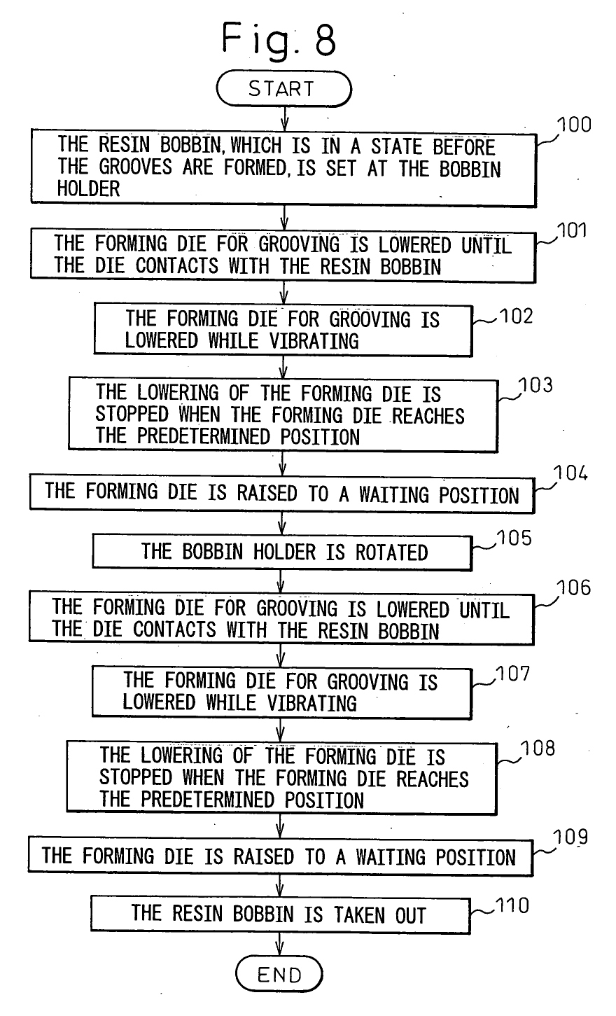

FIG. 8 is a flow chart showing the procedure of forming grooves. First, the resin bobbin 90, which is in a state before the grooves are formed, is set at the bobbin holder 1 (step 100). Next, the cylinder 4 is operated and the forming die 2 for grooving attached to the vibrator 3 is lowered. When the pushing face 20 comes into contact with a surface of the resin bobbin 90, this lowering motion of the forming die 2 for grooving is stopped (step 101).

Next, while the vibrator 3 is being operated so as to vibrate the forming die 2 for grooving, the cylinder 4 is operated again and the lowering motion of the forming die 2 for grooving is resumed (step 102). The forming die 2 for grooving is lowered until it reaches a predetermined position. When the forming die 2 for grooving has reached the predetermined position, it is stopped (step 103). Then, vibration of the vibrator 3 is stopped and the forming die 2 for grooving is raised to a waiting position (step 104). In this way, a plurality of grooves 98 are simultaneously formed in the two respective corners 96 of the resin bobbin 90.

Next, the bobbin holder 1 is rotated around the central axis of the resin bobbin 90 by 180° (step 105). After that, in the same manner, the groove formation is conducted on the remaining two corners 96 of the resin bobbin 90. That is, after the forming die 2 for grooving has been lowered until the pushing face 20 comes into contact with the surface of the resin bobbin 90 (step 106), while the vibrator 3 is being operated and the forming die 2 for grooving is being vibrated, the cylinder 4 is operated again and the lowering motion of the forming die 2 for grooving is resumed (step 107). The forming die 2 for grooving is lowered until it reaches a predetermined position. When the forming die 2 for grooving has reached the predetermined position, the lowering motion of the forming die 2 for grooving is stopped (step 108). Then, vibration of the vibrator 3 is stopped, and the forming die 2 for grooving is raised to a waiting position (step 109). In this way, a plurality of grooves 98 are simultaneously formed in the two residual corners 96 of the resin bobbin 90. Finally, the resin bobbin 90 in which the grooves have been formed is taken out from the bobbin holder 1 (step 110). In this way, a series of groove formation conducted on the resin bobbin 90 is completed.

As explained above, in the groove forming device 100 of this embodiment, the grooves 98 of the resin bobbin 90 are formed by pushing the forming die 2 for grooving while it is being vibrated. Therefore, in the case of manufacturing various types of resin bobbins 90, it is possible to decrease the types of the resin bobbins 90. Accordingly, in the case of changing the specification of a coil, it is possible to cope with the change in the specification by only changing the forming die 2 for grooving. Consequently, it is possible to suppress an increase in the manufacturing cost of the resin bobbin. Further, as the grooves 98 are formed after the resin bobbin 90 has been manufactured, the grooves 98 can be formed immediately before the coil is wound around the resin bobbin 90. Accordingly, the occurrence of erroneous assembling, in which a coil of a different diameter is erroneously wound around the resin bobbin, can be prevented.

When the step of vibrating the forming die 2 for grooving and the step of pushing the resin bobbin 90 are simultaneously conducted, the grooves 98 of predetermined shapes can be easily formed. Especially, in the forming die 2 for grooving, a plurality of protruding portions 2A and recess portions 2B are alternately, continuously formed on the pushing face 20 of the forming die 2 for grooving being opposed to the cylindrical portion 92. Due to the foregoing, the grooves 98 having irregularities corresponding to the shapes of the recess portions 2A and the protruding portions 2B can be positively formed. When the shapes and intervals of the recess portions 2A and the protruding portions 2B are changed, design of the grooves 98 can be easily changed.

The forming die 2 for grooving includes an opposing face (a pushing face 20) opposing to a portion (a range within 180° in this embodiment) of the cylindrical portion 92 in the circumferential direction. Due to the foregoing, the grooves 98 can be formed when the forming die 2 for grooving is pushed to the cylindrical portion 92 in one direction. Therefore, the process can be simplified. When the forming die 2 for grooving is downsized, the holding mechanism of holding the forming die 2 for grooving and the vibrator 3 for giving vibration can be downsized.

When the steps of forming grooves are repeated a plurality of times by changing a position of the cylindrical portion 92 to which the forming die 2 for grooving is pushed, grooves can be formed on all circumference of the cylindrical portion 92 by using a small forming die 2 for grooving with respect to the cylindrical portion 92. Therefore, the grooving device 100 can be downsized.

After the forming die 2 for grooving has been pushed to the cylindrical portion 92, the forming die 2 for grooving is vibrated, and after the forming die 2 for grooving is moved in the pushing direction by a predetermined distance, vibration is stopped. Due to the foregoing, grooves 98, the depths of which are predetermined, can be formed in the resin bobbin 90 in the radial direction. When the forming die 2 for grooving is vibrated after the completion of pushing, the positioning accuracy can be enhanced at the time of pushing.

A cross section of the cylindrical portion 92 of the resin bobbin 90 is polygonal and the grooves 98 are formed at corners of the polygonal section. Due to the foregoing, an area in which the grooves 98 are formed can be reduced. Therefore, a position of the coil can be restricted by these grooves 98.

When ultrasonic vibration is given by the vibrator 3 to the forming die 2 for grooving, the forming die 2 for grooving can be relatively easily vibrated, and the groove forming device 100 can be downsized.

In this connection, it should be noted that the present invention is not limited to the above specific embodiments. Variations may be made by those skilled in the art without departing from the spirit and scope of the invention. For example, explanations are made into the above embodiment in which the cross section of the cylindrical portion 92 of the resin bobbin 90 is polygonal, however, the cross section of the cylindrical portion 92 of the resin bobbin 90 may be circular or elliptical.

In the above embodiment, the grooves 98 are formed only in the corners 96 of the cylindrical portion 92. However, when the shape of the pushing face 20 of the forming die 2 for grooving is made to agree with the outer circumferential shape of the cylindrical portion 92, the grooves 98 may be formed all over the circumference of the cylindrical portion 92.

In the above embodiment, the grooves 98 are formed in the resin bobbin 90 when the forming die 2 for grooving is pushed being vibrated. However, the forming die 2 for grooving may be simultaneously heated. Due to the foregoing, the grooves can be more easily formed in the resin bobbin 90.

In the above embodiments, the forming die 2 for grooving is vibrated by the vibrator 3. However, on the contrary, the vibrator may be attached to the bobbin holder 1 side, and the resin bobbin 90 held by the bobbin holder 1 may be vibrated. Alternatively, the forming die 2 for grooving and the resin bobbin 2 may be simultaneously vibrated.

In the above embodiments, the forming die 2 for grooving is lowered by the cylinder 4. However, a motor may be used for the mechanism of lowering the forming die 2 for grooving. Instead of lowering the forming die 2 for grooving, the resin bobbin 90 held by the bobbin holder 1 may be raised.

In the above embodiments, the forming die 2 for grooving is vibrated by ultrasonic vibration generated by the vibrator 3. However, the forming die 2 for grooving may be vibrated by a method other than using a means for ultrasonic vibration.

While the invention has been described by reference to specific embodiments chosen for purposes of illustration, it should be apparent that numerous modifications could be made thereto by those skilled in the art without departing from the basic concept and scope of the invention.

1. A method of forming grooves in a resin bobbin, the resin bobbin having a cylindrical portion around which a coil is wound, a plurality of grooves being formed on a surface of the cylindrical portion in the winding direction of the coil,
the method of forming grooves in a resin bobbin comprising:
a first step of pushing a forming die for grooving onto the surface of the cylindrical portion;
a second step of vibrating at least one of the forming die for grooving and the resin bobbin; and
a third step of separating the forming die for grooving from the surface of the cylindrical portion after the completion of grooving conducted on the cylindrical portion.

2. A method of forming grooves in a resin bobbin according to claim 1, wherein the first and the second step are simultaneously conducted.

3. A method of forming grooves in a resin bobbin according to claim 1, wherein a plurality of protruding portions and recess portions are alternately and continuously formed on a pushing face of the forming die for grooving being opposed to the cylindrical portion.

4. A method of forming grooves in a resin bobbin according to claim 1, wherein the forming die for grooving includes an opposing face opposing to a portion of the cylindrical portion in the circumferential direction.

5. A method of forming grooves in a resin bobbin according to claim 4, wherein the first to the third step are repeated a plurality of times by changing the position of the cylindrical portion to which the forming die for grooving is pushed.

6. A method of forming grooves in a resin bobbin according to claim 1 wherein, after the forming die for grooving has been pushed to the cylindrical portion in the first step, the forming die for grooving is vibrated in the second step, and after the forming die for grooving is moved in the pushing direction by a predetermined distance, vibration is stopped.

7. A method of forming grooves in a resin bobbin according to claim 1, wherein a cross section of the cylindrical portion is polygonal and the grooves are formed at corners of the polygonal section.

8. A method of forming grooves in a resin bobbin according to claim 1, wherein ultrasonic vibration is given in the second step.

9. A method of forming grooves in a resin bobbin according to claim 1, wherein the second step is conducted in a state in which the forming die for grooving is heated.

10. A device of forming grooves comprising:
a bobbin holder of holding a resin bobbin;
a forming die for grooving in which protruding portions and recess portions are alternately formed on a pushing face for pushing the resin bobbin;
a pushing mechanism for pushing the forming die for grooving onto a surface of the cylindrical portion of the resin bobbin; and
a vibrating mechanism of vibrating at least one of the forming die for grooving and the resin bobbin at the time of pushing by the pushing mechanism.
